(19) United States
(12) Patent Application Publication
(10) Pub. No.: US 2005/0235068 A1
(43) Pub. Date: Oct. 20, 2005

(54) Computer system sharing an I/O device between logical partitions

(76) Inventors: Toshiomi Moriki, Kunitachi (JP); Yuji Tsushima, Hachioji (JP)

Correspondence Address: Stanley P. Fisher;Reed Smith LLP, Suite 1400, 3110 Fairview Park Drive, Falls Church, VA, 22042-4503, US

(21) Appl. No.: 11/105,481

(22) Filed: Apr. 14, 2005

(30) Foreign Application Priority Data
Apr. 19, 2004 (JP) 2004-122455

(51) Int. Cl. G06F 13/28

(52) U.S. Cl. 710/5; 710/22

(57) ABSTRACT

Provided is a computer including a physical computer that includes CPU's (1a and 1b), a memory (5), a PCI bus (7) for interconnecting I/O devices (#0 to #3), and a south bridge (6) for controlling the PCI bus (7), a hypervisor that divides the physical computer into a plurality of LPAR's and controls resource allocation of the physical computer, an I/O device allocation unit that sets a correlation between the I/O device and the plurality of LPAR's based on a command from the hypervisor, and a parallel process issuing unit that issues a processing request (for DMA transfer or interruption processing) received from the I/O device in parallel to the plurality of LPAR's set by the I/O device allocation unit. Thus, complexity of an on-board circuitry is prevented while dynamic changing of an I/O device of a virtual computer is enabled.

### CLAIM OF PRIORITY

The present application claims priority from Japanese application P2004-122455 filed on Apr. 19, 2004, the content of which is hereby incorporated by reference into this application.

### BACKGROUND

This invention relates to a virtual computer system, and more particularly to a technology of dynamically changing allocation of a plurality of logical partitions and I/O devices.

An increase in the number of servers has been accompanied by an increase in operational complexity, causing a problem of operational costs. Accordingly, server integration that integrates a plurality of servers into one has attracted attention as a technology of reducing operational costs. As a technology of realizing server integration, there has been known a virtual computer that logically divides one computer at an optional ratio. A physical computer is divided into a plurality of logical partitions (LPAR's) by firmware (or middleware) such as a hypervisor, computer resources (CPU, main memory, and I/O) are allocated to each LPAR, and an OS is operated on each LPAR. The CPU is used in a time-division manner, and thus flexible server integration can be realized.

As the virtual computer, there has been known a computer that transfers data between an I/O device and an OS on each logical partition by direct memory access (DMA) (e.g., JP 2002-318701 A).

### SUMMARY

In the case of realizing the virtual computer on an open server (e.g., blade server or PC server), an I/O device must be shared by a plurality of logical partitions (OS's on logical partitions) because the open server includes only a small number of I/O devices to be mounted. The sharing of the I/O device necessitates DMA transfer between the I/O device and the OS on each logical partition, or transmission of an I/O interruption from the I/O device to the sharing OS's.

However, in the conventional example, DMA transfer to a logical partition other than that allocated to the I/O device is inhibited. Thus, as the I/O device can always notify only one logical partition, a plurality of OS's cannot share one I/O device, causing a problem of a shortage of I/O devices allocated to the OS's.

This invention has been made in view of the aforementioned problem, and it is therefore an object of this invention to realize a virtual computer on an open server by allowing OS's on a plurality of logical partitions to share one I/O device.

According to an embodiment of this invention, there is provided a computer including: a physical computer that includes a CPU, a main memory, an I/O bus connecting an I/O device, and an I/O control unit controlling the I/O bus; firmware (a hypervisor) that divides the physical computer into a plurality of logical partitions, operates an OS on each logical partition, and controls resource allocation of the physical computer to each logical partition; an I/O device allocation unit that sets a correlation between the I/O device and the plurality of logical partitions based on a command from the firmware; a processing request reception unit that receives a processing request (for DMA transfer or interruption processing) from the I/O device; and a parallel process issuing unit that issues the received processing request in parallel to the plurality of logical partitions set by the I/O device allocation unit.

Thus, according to this invention, by setting the correlation between each I/O device and the plurality of logical partitions, it is possible to issue the processing request from the I/O device in parallel to the plurality of logical partitions. Accordingly, when one I/O device is shared by the plurality of logical partitions, the processing request of the I/O device can be issued only to the logical partition which needs the request. As a result, it is possible to realize a virtual computer even on the open server which includes only a small number of I/O devices.

### BRIEF DESCRIPTION OF THE DRAWINGS

FIG. 1 is a system diagram showing a configuration of a physical computer according to a first embodiment of this invention.

FIG. 2 is a system diagram showing a software configuration of a virtual computer operated on the physical computer.

FIG. 3 is a system diagram showing a south bridge in which a DMA control unit is a center.

FIG. 4 is an explanatory diagram showing an example of a device register.

FIG. 5 is an explanatory diagram showing an example of a parallel transfer register.

FIG. 6 is a system diagram showing an example of an I/O device.

FIG. 7 is a diagram showing an example of DMA transaction.

FIG. 8 is a diagram showing a relation among a physical address space, a logical address space of each LPAR, and a DMA buffer.

FIG. 9 is a system diagram showing a south bridge in which an interruption control unit is a center according to a second embodiment of this invention.

FIG. 10 is a system diagram showing an example of an I/O device according to the second embodiment.

FIG. 11 is an explanatory diagram showing an example of a parallel interruption register according to the second embodiment.

FIG. 12 is a flowchart showing an example of a share setting process carried out by a hypervisor according to the second embodiment.

FIG. 13 is a time chart showing a flow of an interruption process from the I/O device according to the second embodiment.

FIG. 14 is a system diagram showing an example of a hardware configuration of interruption process completion notification according to the second embodiment.

### DETAILED DESCRIPTION OF THE PREFERRED EMBODIMENTS

Hereinafter, the preferred embodiments of this invention will be described with reference to the accompanying drawings.

<First Embodiment>

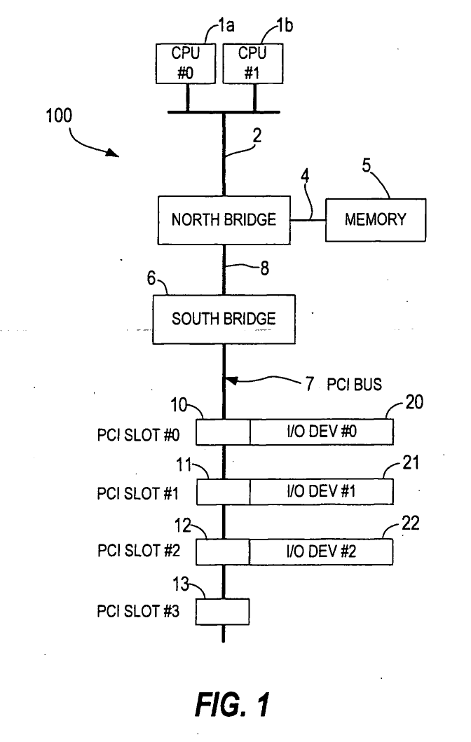

FIG. 1 shows a configuration of a physical computer (open server) 100 for operating a virtual computer system according to a first embodiment of this invention. CPU's 1a and 1b are connected through a front side bus 2 to a north bridge 3.

The north bridge 3 is connected through a memory bus 4 to a memory (main memory) 5, and connected through a bus 8 to a south bridge 6. A PCI bus 7, a legacy device (not shown), and a disk interface (not shown) are connected to the south bridge 6, which can be accessed from the CPU's 1a and 1b. It should be noted that the south bridge 6 only needs to be a controller for controlling an I/O bus of a PCI bus 9 or the like, and the north bridge 3 only needs to be a controller for controlling the memory 5.

The PCI bus (I/O bus) 7 includes a data bus, an address bus, and a signal line of an interruption signal or the like (not shown), and is shared by PCI slots #0 to #3 (10 to 13 in the drawing).

I/O devices #0 to #2 (20 to 22 in the drawing) are connected to the PCI slots #0 to #3, respectively.

The number of CPU's constituting the physical computer 100 may be one, or two or more. When the number of CPU's is two or more, the CPU's 1a and 1b are tightly coupled multiprocessors which share the memory 5.

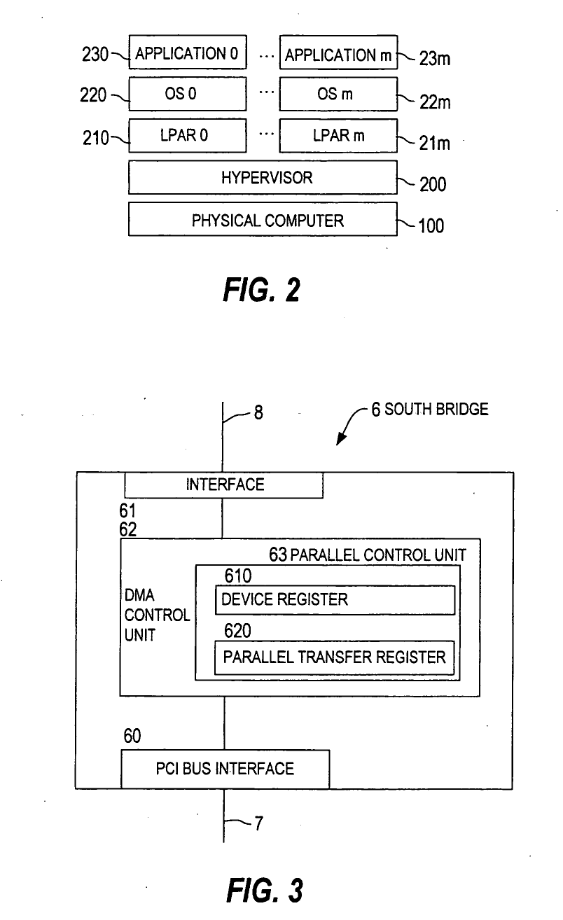

Now, referring to FIG. 2, software for realizing a virtual computer on the physical computer 100 will be described in detail.

A hypervisor 200 (firmware or middleware) is operated on the physical computer 100. The hypervisor 200 divides the physical computer 100 into two or more logical partitions (LPAR's) LPAR 0 (210) to LPAR m (21m), and manages allocation of computer resources.

OS 0 (220) to OS m (22m) are operated on the LPAR 0 to LPAR m, and applications 0 (230) to m (23m) are operated on the OS's.

The hypervisor 200 allocates resources (computer resources) of the CPU's 1a and 1b, the memory 5, and the I/O devices #0 to #2 of the PCI slots #0 to #3 (computer resources) of the physical computer 100 to the LPAR's (210 to 21 m). The hypervisor 200 can allocate a plurality of OS's (220 to 22 m) to one I/O device. In other words, the I/O devices #0 to #3 are constituted so that they can be shared by the plurality of LPAR's 0 to m.

Further, when executing DMA transfer between each of the I/O devices #0 to #3 and each of the OS's 0 to m (220 to 22 m), the hypervisor 200 sets DMA transfer on the south bridge 6 at the time of booting each of the OS's 0 to m (described later).

The DMA transfer is realized in a manner that the south bridge 6 executes writing in a predetermined area of the memory 5 through the north bridge 3 in response to DMA transfer requests from the I/O devices #0 to #3.

Hereinafter, this embodiment will be described by way of case in which the plurality of OS's share one I/O device and the south bridge 6 controls DMA transfer. The description below refers to a case in which two LPAR's 0 and 1 share one I/O device #0. However, this invention can be similarly applied to a case in which two or more OS's share the other I/O device.

FIG. 3 is a system diagram of the south bridge 6 in which a DMA control unit 62 is a center. The south bridge 6 includes an interface 61 for connecting the south bridge 6 to the north bridge 3 on the CPU side, a PCI bus interface 60 connected to the PCI bus 7, and the DMA control unit 62 for writing data in the memory 5 in response to DMA transfer requests from the I/O devices #0 to #3 shown in FIG. 1.

Here, provided in the DMA control unit 62 is a parallel control unit 63 for distributing (parallelizing) DMA transfer to a plurality of OS's (LPAR's) from one I/O device in response to a command from the hypervisor 200.

The parallel control unit 63 includes a device register 610 for setting sharing of the I/O devices #0 to #3, and a parallel transfer register 620 provided to each I/O device for indicating a share LPAR and a DMA buffer address of each LPAR. When a DMA transfer request comes from the shared I/O device, DMA transfer is carried out to a plurality of addresses of the memory 5 indicated by the parallel transfer register 620.

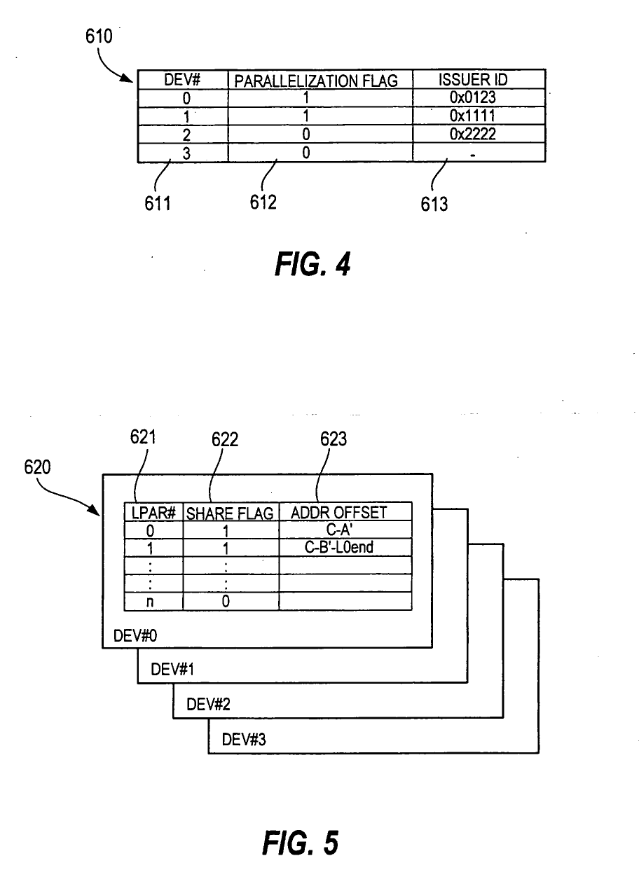

Referring to FIG. 4, device registers 610 are set by a number equal to the number of I/O devices #0 to #3, and include a parallelization flag 612 indicating whether or not to execute DMA transfer in parallel to the plurality of LPAR's corresponding to a device number 611, and an issuer ID of an I/O device. “1” of the parallelization flag Fp indicates that parallel DMA transfer is executed, while “0” thereof indicates that parallel DMA transfer is not executed. The issuer ID indicates an ID on the PCI bus 7 of the I/O device, and it is information containing a bus number, a device number, and a function number defined by PCI Local Bus Specification Rev. 2.2 or the like.

Next referring to FIG. 5, the parallel transfer register 620 includes registers independent for the I/O devices #0 to #3. Corresponding to an LPAR number 621 set by the hypervisor 200, a share flag 622 indicating presence/absence of sharing and an address offset value 623 of a transfer destination are set for each LPAR number 624.

In FIG. 5, reference numeral 620 indicates an example of the parallel transfer register 620 of the I/O device #0, and share flags of the LPAR's 0 and 1 set to 1, thereby indicating that the I/O device #0 is shared by the two LPAR's 0 and 1. The address offset value 623 of the transfer destination indicates that a DMA buffer address of the I/O device #0 of the LPAR 0 is C-A′, and a DMA buffer address of the I/O device #0 of the LPAR 1 is C-B′-L 1st. The L 1st represents a start physical address of the LPAR 1. A start physical address of the LPAR 0 is 0h, and a logical address space and a physical address space coincide with each other.

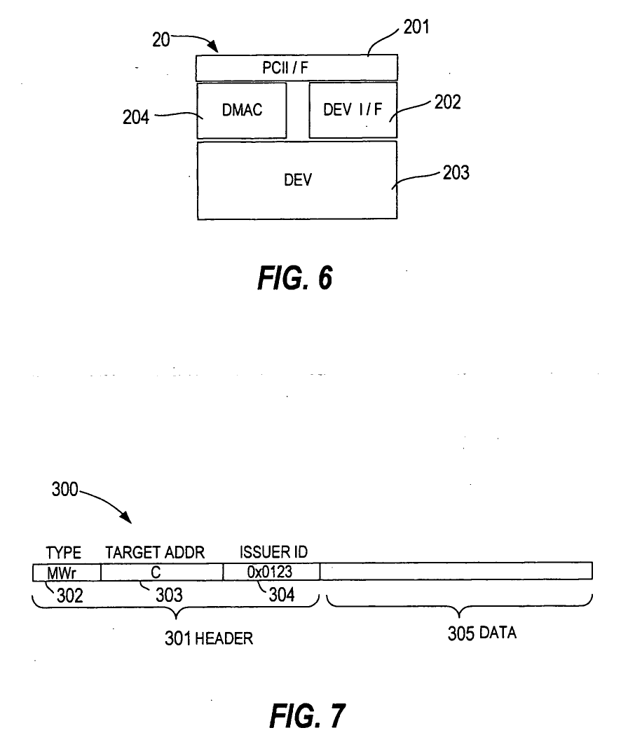

Next, referring to FIG. 6, the I/O device #0 includes a PCI bus interface 201, a device interface 202, an I/O device main body 203, and a DMA controller 204. For example, when the I/O device #0 is a network interface card (NIC), upon occurrence of reception, the DMA controller 204 issues to the south bridge 6 a DMA transaction for transferring reception data.

For example, the DMA transaction 300 is structured as shown in FIG. 7. A header 301 includes request contents (TYPE in the drawing) 302, a transfer destination address 303, and an issuer ID 304. Data 305 is added to the end of the header 301.

For the transfer destination address 303, a hypervisor DMA buffer address (C in the drawing) set by the hypervisor 200 is set at the time of booting the physical computer 100. The transfer destination address 303 is set in a DMA register (not shown) of the DMA controller 204. The issuer ID 304 is the same as an issuer ID 613 of the device register 610.

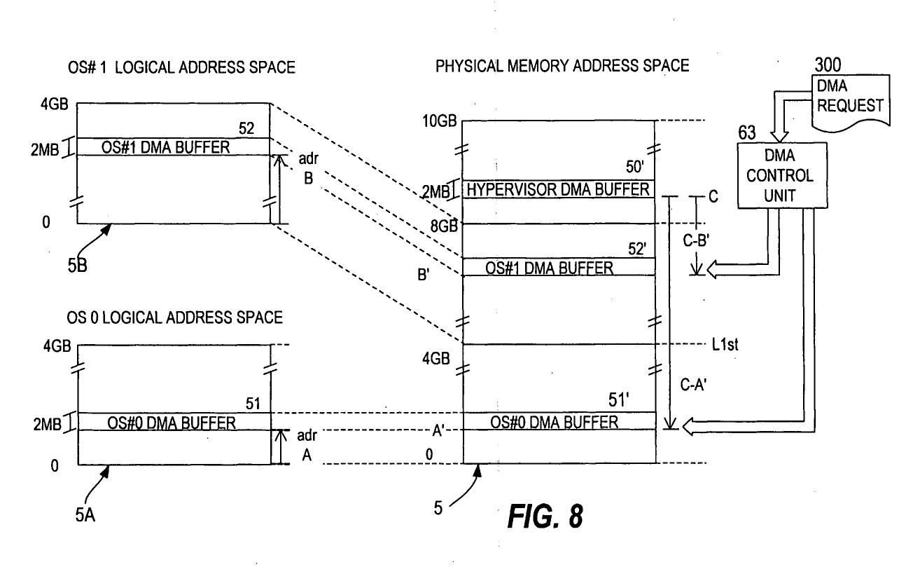

Now, referring to FIG. 8, a relation among a memory space of the OS 0 of the LPAR 9 set in the memory 5, a memory space of the OS 1 of the LPAR 1, and the hypervisor DMA buffer will be described.

The memory 5 includes physical addresses 0 to 10 GB. Among those, an address space (area) of 0 to 4 GB is allocated to the OS 0, an address space of 4 GB to 8 GB is allocated to the OS 1, and an address space of 2 MB from a physical address C of 8 GB or more is allocated to a hypervisor DMA buffer 50.

The physical address space allocated to the OS 0 of the LPAR 0 is used as a logical address space 5A of 0 to 4 GB by the OS 0, and a DMA buffer 51 for the OS 0 is secured in an address space of 2 MB from a logical address A at the time of booting the OS 0. The DMA buffer 51 corresponds to the I/O device #0.

On the other hand, the physical address space of 4 to 8 GB allocated to the OS 1 of the LPAR 1 is used as a logical address space 5B of 0 to 4 GB by the OS 1, and a DMA buffer 52 for the OS 1 is secured in an address space of 2 MB from a logical address B at the time of booting the OS 1. The DMA buffer 52 corresponds to the I/O device #0.

Here, the hypervisor 200 that manages physical addresses manages physical addresses A′ and B′ of the OS DMA buffers 51 and 52 from the DMA buffers 51 and 52 secured by the OS's 0 and 1, respectively.

Next, an example of sharing the I/O device #0 by the OS's 0 and 1 of the LPAR's 0 and 1 and executing DMA transfer will be described.

Upon bootup of the OS's 0 and 1, the DMA buffers 51 and 52 are secured as described above, respectively, and the OS's 0 and 1 request the hypervisor 200 to allocate the I/O device #0 and to execute DMA transfer.

Since the plurality of OS's have requested the DMA transfer of the I/O device #0, the hypervisor 200 sets 1 as the parallelization flag of a device number 0 (I/O device #0) of the device register 610 of FIG. 4, reads an issuer ID from the PCI bus interface 201 of the I/O device #0, and sets the ID to the issuer ID of the device register 610. At the time of booting the physical computer 100, as described above, the address C of the hypervisor DMA buffer 50 is set as a DMA transfer address of the I/O device #0 in the DMA controller 204.

Next, to execute parallel DMA transfer between the I/O device #0 and the OS's 0 and 1, the hypervisor 200 sets 1 as the share flags of the LPAR's 0 and 1 of the parallel transfer register 620 of the I/O device #0. Then, the hypervisor 200 sets offset of a hypervisor DMA buffer address C and a physical address A′ of the DMA buffer 51 for the OS 0 (C−A′=C−A) in the transfer destination address offset value 623 of the parallel transfer register 620.

Similarly, the hypervisor 200 sets offset of the hypervisor DMA buffer address C and a physical address B′ of the DMA buffer 52 for the OS 1 (C−B′=C−B−L 1st) as the transfer destination address offset value 623 of the parallel transfer register 620 of the I/O device #0.

When DMA transaction 300 occurs from the I/O device #0 upon completion of the bootup, a header 301 and data 305 of TYPE (=MWr=memory write request) similar to that shown in FIG. 7 are sent from the I/O device #0 to the south bridge 6.

The DMA control unit 62 extracts an issuer ID 304 from the header 301, and compares the ID with the issuer ID of the device register 610 to determine that a DMA transfer source is the I/O device #0. Determination is simultaneously made as to whether the parallelization flag is 1 or not. Parallel transfer is executed as described below when the flag is 1. When the flat is 0, parallel transfer is not executed, while data is transferred to the transfer destination address (i.e., hypervisor DMA buffer address) 303 described in the header 301 of the DMA transaction 300.

When the parallelization flag is 1, the DMA control unit 62 refers to the I/O device #0 of the parallel transfer register 620 to retrieve an LPAR in which a share flag is set to 1. Then, in FIG. 5, since the share flag is set in the LPAR 0, the transfer address offset value (C−A′) is read, and this offset value is subtracted from the transfer address 303 (=C) extracted from the DMA transaction 300. The transfer destination address of the DMA transaction 300 is the hypervisor DMA buffer address C as described above. Accordingly, referring to FIG. 8, an obtained address is C−(C−A′)=A′, whereby an address A′ of a DMA buffer 51′ corresponding to the physical address space of the LPAR 0 is obtained.

The DMA control unit 62 transfers the data 305 of the DMA transaction 300 to the physical address A′ of the memory 5, and writes data in the DMA buffer 51 for the OS 0.

The DMA control unit 62 further searches in the parallel transfer register 620, reads a transfer destination address offset value (C−B′) since the share flag has been set in the LPAR 1, and subtracts this offset value from the transfer destination address 303 (=C) extracted from the DMA transaction 300. Similarly to the above, since the transfer destination address of the DMA transaction 300 is the hypervisor DMA buffer address C as described above, an obtained address is C−(C−B′)=B′, whereby an address B′ of a DMA buffer 52′ corresponding to the physical address space of the LPAR 1 is obtained.

The DMA control unit 62 transfers the data 305 of the DMA transaction 300 to the physical address B′ of the memory 5, and writes data in the DMA buffer 52 for the OS 1.

Accordingly, the DMA control unit 62 sequentially transfers data to the physical address defined by subtracting the offset value from the address indicated by the DMA transaction 300 in the LPAR in which the share flag of the parallel transfer register 620 has been set, whereby the DMA transfer request can be written in parallel in the plurality of LPAR's from one I/O device.

Thus, even on the open server having a small number of I/0 devices, it is possible to realize a virtual computer which includes a plurality of LPAR's by sharing an I/O device. As a result, the number of servers can be reduced.

Furthermore, the DMA transaction 300 of the I/O devices #0 to #3 of the PCI bus 7 is parallelized in the south bridge 6. Thus, the I/O device can be shared by the plurality of OS's by parallelizing DMA transfer while preventing an increase in data traffic of the PCI bus 7.

This embodiment has been described by way of example in which the parallel control unit 63 is disposed in the south bridge 6. However, the parallel control unit 63 may be disposed in the north bridge 3 (not shown).

<Modified Example 1>

According to a first modified example, the parallel control unit 63 is disposed in the south bridge 6. However, a parallel transfer register 620 may be disposed in the DMA controller 204 of the I/O devices #0 to #3 shown in FIG. 6, and the DMA transaction 300 from the I/O devices #0 to #3 may be parallelized.

In this case, the parallel transfer register 620 may be disposed for each of the I/O devices #0 to #3, and the south bridge 6 only needs to include the DMA control unit 62 similar to that of the conventional case. Then, a hypervisor 200 accesses the parallel transfer register 620 of each of the I/O devices #0 to #3 to set a share flag 622 and the offset value 623.

When DMA transfer occurs at the I/O devices #0 to #3, the DMA transfer is executed with respect to a plurality of OS's (CPU's) in accordance with the offset value 620 of the parallel transfer registers 620 of the I/O devices #0 to #3.

Thus, as in the case of the first embodiment, sharing of the I/O devices #0 to #3 by the plurality of OS's (LPAR's) can be realized. In this case, since the parallel transfer register 620 is disposed on the I/O device side, the device register 610 is made unnecessary, thereby simplifying a configuration.

<Second Embodiment>

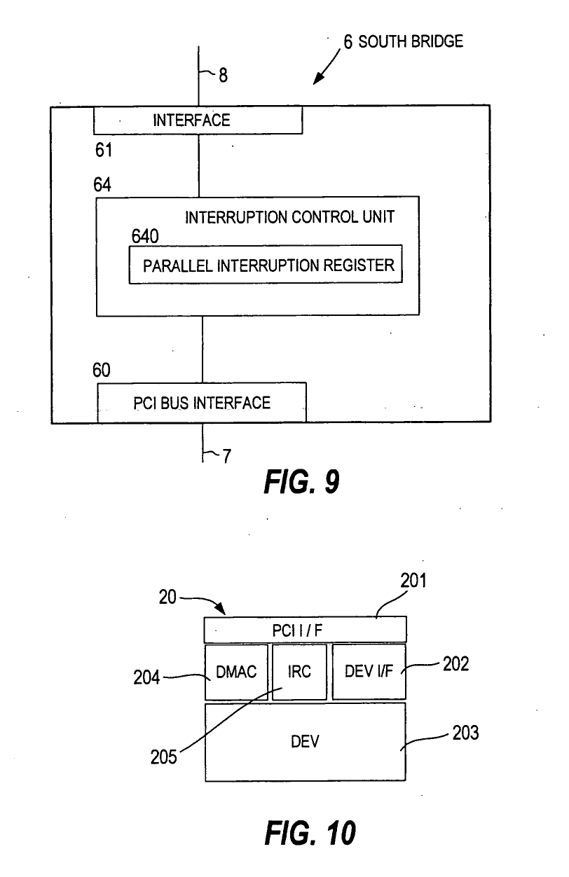

FIGS. 9 to 14 show a second embodiment, showing an example in which the south bridge 6 of the first embodiment includes an interruption control unit 64 for notifying OS's on a plurality of LPAR's sharing an I/O device of I/O interruption (external interruption) from I/O devices #0 to #3.

FIG. 9 is a system diagram showing the south bridge 6 of the first embodiment in which the interruption control unit 64 for notifying the plurality of OS's (CPU's 1a and 1b) of interruption requests (interruption signals) from the I/O devices #0 to #3.

The south bridge 6 includes an interface 61 for connecting the south bridge 6 to the north bridge 3 of the CPU side, the PCI bus interface 60 connected to the PCI bus 7, and the interruption control unit 64 for notifying the CPU's 1a and 1b of interruption in accordance with I/O interruption from the I/O devices #0 to #3 shown in FIG. 1.

Referring to FIG. 10, each of the I/0 devices #0 to #3 includes a PCI bus interface 201, a device interface 202, an I/O device main body 203, a DMA controller 204, and an interruption controller 205. For example, when the I/O device #0 is a network interface card (NIC), upon occurrence of reception, the interruption controller 205 issues to the south bridge 6 an interruption signal for notifying I/O interruption.

Other components are similar to those of the first embodiment, and thus description thereof will be omitted to avoid repetition.

Here, provided in the interruption control unit 64 of the south bridge 6 is a parallel interruption register 640 for distributing (parallelizing) I/O interruption from one I/O device to a plurality of OS's (CPU's) in response to a command from a hypervisor 200.

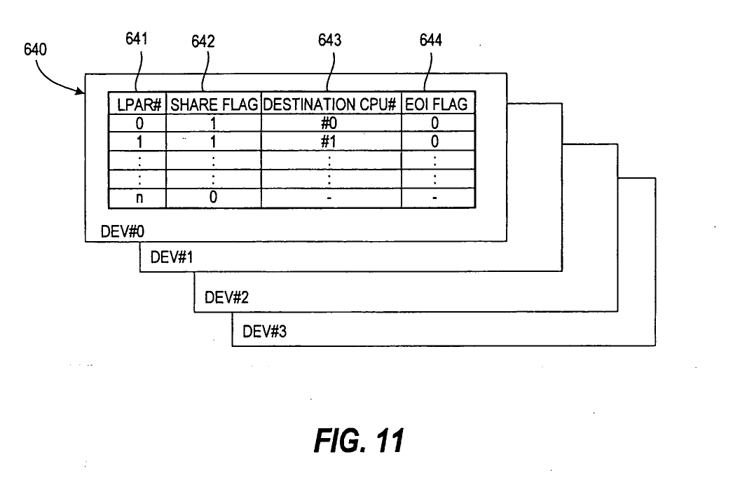

Next, referring to FIG. 11, the parallel interruption register 640 includes registers independent for the I/O devices #0 to #3. Corresponding to an LPAR number 641 set by the hypervisor 200, a share flag 642 indicating presence/absence of sharing, a CPU identifier 643 indicating an address of interruption notification, and an area for storing an end-of-interrupt (EOI) flag 644 indicating interruption processing completion notification from the CPU are set for each LPAR number 641.

In FIG. 11, reference numeral 640 indicates an example of a parallel interruption register 640 of the I/O device #0, and the share flags 642 of the LPAR 0 and the LPAR 1 are set to “1”, indicating that the I/O device #0 is shared by the two LPAR's 0 and 1.

When the CPU 1a (CPU #0 of FIG. 1) is allocated to the LPAR 0 and the CPU 1b (CPU #1 of FIG. 1) is allocated to the LPAR 1, in the parallel interruption register 640, #0 shown in FIG. 1 is set in a CPU identifier 643 of the LPAR 0, and #1 shown in FIG. 1 is set in a CPU identifier 643 of the LPAR 1.

Further, since there is no interruption processing completion notification at present, “0” is set in EOI flags 644 of the LPAR's 0 and 1. When the CPU allocated to the LPAR notifies completion of interruption processing, the EOI flags 644 are changed to 1. The EOI flag 644 is reset to “0” by the interruption control unit 64 each time I/O interruption occurs.

Next, an example of sharing the I/O device #0 by the LPAR's 0 and 1 and parallelizing and notifying I/O interruption by the south bridge 6 will be described.

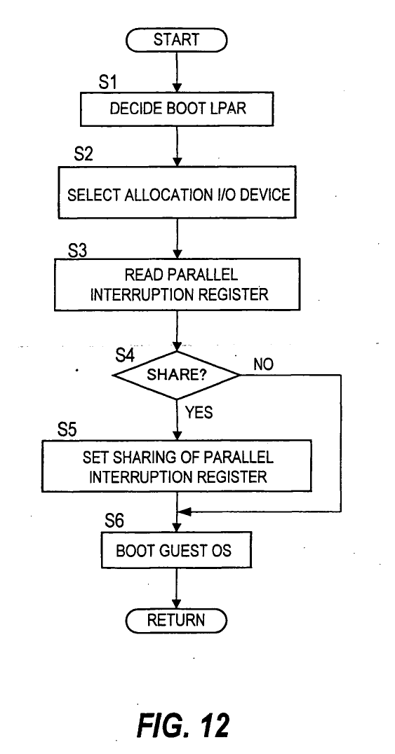

First, a flowchart of FIG. 12 will be used to describe a setting process of parallel interruption executed by the hypervisor 200 executed by the physical computer 100 each time the OS is booted on the LPAR.

The hypervisor 200 decides an LPAR and a CPU for booting an OS (S1), and selects I/O devices to be allocated to this OS (LPAR) (S2). Next, the parallel interruption register 640 corresponding to the selected I/O devices #0 to #3 is read from the south bridge 6 (S3), and determination is made as to whether or not to share with other LPAR by referring to a share flag (S4). This determination may be made by referring to a parallelization flag 612 of a device register 610 disposed in the south bridge 6 as in the case of the first embodiment.

In the case of no sharing, the process proceeds to a step S6 to boot an OS (guest OS). In the case of sharing, the share flag 642 corresponding to the LPAR for booting the OS is set to “1”, and share flags of sharing LPAR's are set to “1”. Then, an identifier 643 of a CPU allocated to each LPAR is set (S5).

After the parallel interruption register 640 of the south bridge 6 has been set, the guest OS is booted (S6).

An interruption controller 205 of the I/O devices #0 to #3 is initialized at the time of booting the physical computer 100, and an interruption number is set in the interruption controller 205.

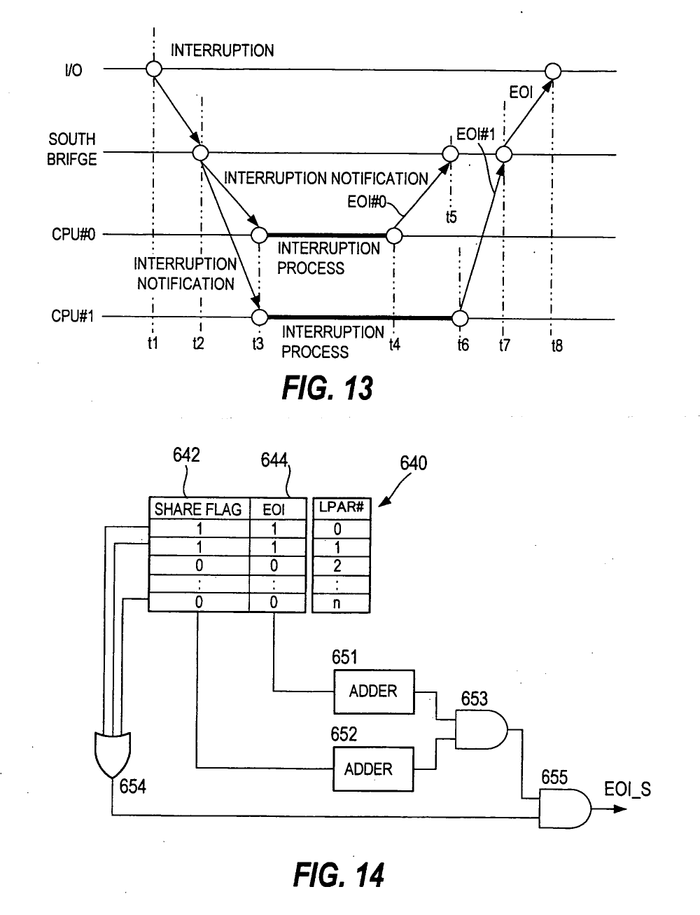

Next, referring to a time chart of FIG. 13, a process from I/O interruption to completion notification will be described.

When I/O interruption occurs, the I/O device sends an interruption signal corresponding to an interruption number to the interruption control unit 64 of the south bridge 6 (t1).

Upon reception of the interruption signal from the I/O device, the interruption control unit 64 of the south bridge 6 specifies an I/O device from an interruption identifier. Then, determination is made as to sharing by referring to a share flag 642 of the parallel interruption register 640 corresponding to the specified I/O device. When sharing is not determined, a predetermined CPU (e.g., CPU 1a) is notified of I/O interruption.

On the other hand, when sharing is determined, I/O interruption notification is executed for all CPU identifiers 643 of destinations set in the parallel interruption register 640 (t2). In the example of FIG. 11, the CPU's 1a and 1b of the LPAR's 0 and 1 is notified of the I/O interruption. At this time, the interruption control unit 64 sets the EOI flags 644 of the LPAR's 0 and 1 to “0”.

Each of the CPU's #0 and #1 that have received the notification starts interruption processing (t3). For example, when the CPU #0 first completes interruption processing, the CPU #0 notifies the interruption control unit 64 of the south bridge 6 of the interruption processing completion (EOI #0) (t4). The interruption control unit 64 that has received the notification sets “1” as an EOI flag having the notified CPU identifier from among the EOI flags 644 of the parallel interruption register 640 (t5).

At this time, the CPU #1 is executing interruption processing. Since the EOI flag 644 corresponding to the CPU #1 is “0”, the interruption control unit 64 withholds notification of I/O interruption processing completion to the I/O device.

Upon completion of the interruption processing, the CPU #1 notifies the interruption control unit 64 of the south bridge 6 of the interruption processing completion (EOI #1) (t6). The interruption control unit 64 that has received the notification sets “1” as an EOI flag of the CPU #1 that has received the notification from among the EOI flags 644 of the parallel interruption register 640 (t5).

At this time, all EOI flags become “1” for the LPAR whose share flag 642 is set in the parallel interruption register 640 shown in FIG. 11. Thus, after determining completion of interruption processing at all the CPU's (or OS's), the interruption control unit 64 transmits an interruption processing completion notification EOI to the I/O device of the issuer.

The determination of the interruption processing completion notification for each CPU at the interruption control unit 64 can be made by hardware similar to that shown in FIG. 14.

Referring to FIG. 14, an adder 651 outputs a result of adding together values of the EOI flags 644 of the parallel interruption register 640, and an adder 652 outputs a result of adding together values of the share flags 642 of the parallel interruption register 640. ON is output through a gate 653 when values of the adders 651 and 652 coincide with each other.

On the other hand, ON is output through a gate 654 when any one of the share flags 642 is “1”. When signals of the gates 654 and 653 are both ON, the interruption processing completion notification EOI is transmitted through a gate 655 to the I/O device.

Accordingly, in the case of LPAR in which the share flag 642 has been set, EOI flags 644 of all the LPAR's become “1”, and the interruption control unit 64 sends the interruption processing completion notification EOI to the I/O device for the first time. It should be noted that the gate 654 prevents transmission of EOI by the interruption control unit 64 when the share flags 642 and the EOI flags 644 are all 0.

Thus, the interruption control unit 64 can notify the CPU's (OS's) of the LPAR's, in which the share flags 642 of the parallel interruption register 640 have been set, of I/O interruption in parallel, and one I/O device can be shared by the plurality of LPAR's.

As a result, even on the open server (blade or PC server) having a small number of I/O devices, by sharing the I/O device, a virtual computer equipped with a plurality of LPAR's can be realized, thereby reducing the number of servers.

The second embodiment has been described by way of example in which the interruption control unit 64 is disposed in the south bridge 6. However, the interruption control unit 64 may be disposed in the north bridge 3 (not shown).

<Modified Example 2>

According to a second modified example, the interruption control unit 64 is disposed in the south bridge 6. However, a parallel interruption register 640 may be disposed in the interruption controller 205 of the I/O devices #0 to #3 shown in FIG. 10, and interruption signals from the I/O devices #0 to #3 may be parallelized.

In this case, the parallel interruption register 640 may be disposed for each of the I/O devices #0 to #3, and the south bridge 6 only needs to include an interruption control unit 64 similar to that of the conventional case. Then, a hypervisor 200 accesses the parallel interruption register of each of the I/O devices #0 to #3 to set a share flag 642, a destination CPU identifier 643, and an EOI flag 644.

When I/O interruption occurs at the I/O devices #0 to #3, to a plurality of OS's (CPU's) are notified of the I/O interruption in accordance with destination CPU's of the parallel interruption registers 640 of the I/O devices #0 to #3.

Each time interruption processing is completed at the CPU's, the EOI flags 644 sequentially become “1”. When EOI flags 644 of all LPAR's in which the share flags 642 of the parallel interruption register 640 have been set become 1, an interruption controller 205 notifies the I/O device of interruption processing completion.

Thus, as in the case of the second embodiment, sharing of the I/O devices #0 to #3 by the plurality of OS's (LPAR's) can be realized.

According to each of the embodiments, the front side bus 2 is the share bus. However, the front side bus may be a point-to-point crossbar type bus, and the north and south bridges 3 and 6 can be similarly interconnected through the crossbar type bus. Moreover, the memory bus 4 is connected to the north bridge 3. However, a configuration may be employed in which the memory bus is connected to the CPU's 1a and 1b.

Furthermore, each of the embodiments is directed to the example of the physical computer 100 equipped with one PCI bus. However, this invention can be applied to a physical computer equipped with a plurality of I/O buses (not shown), and to a physical computer equipped with a plurality of different I/O buses.

As described above, according to this invention, DMA transfer or I/O interruption from the I/O device can be executed in parallel to the plurality of LPAR's. Thus, it is possible to provide a physical computer (server or personal computer) optimal for realizing virtual computers which share an I/O device.

While the present invention has been described in detail and pictorially in the accompanying drawings, the present invention is not limited to such detail but covers various obvious modifications and equivalent arrangements, which fall within the purview of the appended claims.

1. A computer, comprising:
a physical computer that comprises a CPU, a main memory, an I/O bus connecting an I/O device, and an I/O control unit controlling the I/O bus;
firmware that divides the physical computer into a plurality of logical partitions, operates an OS on each logical partition, and controls resource allocation of the physical computer to each logical partition;
an I/O device allocation unit that sets a correlation between the I/O device and the plurality of logical partitions based on a command from the firmware;
a processing request reception unit that receives a processing request from the I/O device; and
a parallel process issuing unit that issues the received processing request in parallel to the plurality of logical partitions set by the I/O device allocation unit.

2. The computer according to claim 1, wherein:
the processing request comprises a request for DMA transfer;
the I/O device allocation unit sets DMA transfer destinations of the plurality of logical partitions as the correlation for each I/O device; and
the parallel process issuing unit executes the requested DMA transfer in parallel to the DMA transfer destinations of the plurality of logical partitions set for each I/O device that has requested the DMA transfer.

3. The computer according to claim 2, wherein the I/O control unit comprises the I/O device allocation unit, the processing request reception unit, and the parallel process issuing unit, and executes the DMA transfer from the I/O device in parallel to the plurality of logical partitions.

4. The computer according to claim 3, wherein the I/O device allocation unit comprises a register for setting the plurality of logical partitions for each I/O device and setting a DMA transfer destination corresponding to a main memory of each logical partition.

5. The computer according to claim 2, wherein the I/O device requests the DMA transfer to the logical partitions, comprises the processing request reception unit, the I/O device allocation unit, and the parallel process issuing unit, and executes the requested DMA transfer in parallel to the DMA transfer destinations of the plurality of logical partitions set by the I/O device.

6. The computer according to claim 1, wherein:
the processing request comprises a request for interruption processing;
the I/O device allocation unit sets CPU's of the plurality of logical partitions as the correlation for each I/O device; and
the parallel process issuing unit executes the requested interruption processing in parallel to the CPU's of the plurality of logical partitions set for each I/O device that has requested the interruption processing.

7. The computer according to claim 6, wherein the I/O control unit comprises the I/O device allocation unit, the processing request reception unit, and the parallel process issuing unit, and executes the interruption processing from the I/O device in parallel to the plurality of logical partitions.

8. The computer according to claim 7, wherein the I/O device allocation unit comprises a register for setting the plurality of logical partitions for each I/O device and setting a CPU corresponding to each logical partition.

9. The computer according to claim 6, wherein the I/O device requests the interruption processing to the logical partitions, comprises the processing request reception unit, the I/O device allocation unit, and the parallel process issuing unit, and issues requests for the interruption processing in parallel to the CPU's of the plurality of logical partitions set by the I/O device.
